(19) United States
(12) Patent Application Publication
(10) Pub. No.: US 2023/0326008 A1
(43) Pub. Date: Oct. 12, 2023

(54) WORK TEST APPARATUS AND METHOD

(71) Applicant: NGK INSULATORS, LTD., Nagoya-City (JP)

(72) Inventors: Takafumi TERAHAI, Nagoya-City (JP); Yoshihiro SATO, Nagoya-City (JP); Kai YAMASHITA, Nagoya-City (JP)

(73) Assignee: NGK INSULATORS, LTD., Nagoya-City (JP)

(21) Appl. No.: 18/188,520

(22) Filed: Mar. 23, 2023

(30) Foreign Application Priority Data
Mar. 28, 2022 (JP) 2022-051253
Feb. 3, 2023 (JP) 2023-015729

(51) Int. Cl. G06T 7/00; G06T 7/60

(52) U.S. Cl. CPC G06T 7/0004; G06T 7/60; G06T 2207/20081

(57) ABSTRACT

Excessive detections of a defect(s) of a specified defect type is reduced. A test apparatus: inputs each of a plurality of fragment images, which are extracted from a test image of a work, into a learning model which receives an image(s) as input and outputs a type(s), and thereby judges the type with respect to each of the plurality of fragment images. The test apparatus judges whether or not a defect of a specified defect type is captured in the test image, on the basis of whether the judged type with respect to each of the plurality of fragment images is the specified defect type or not.

### CROSS-REFERENCE TO PRIOR APPLICATION

This application relates to and claims the benefit of priority from Japanese Patent Application number 2022-051253, filed on Mar. 28, 2022 and Japanese Patent Application number 2023-015729, filed on Feb. 3, 2023 the entire disclosure of which is incorporated herein by reference.

### BACKGROUND

The present invention generally relates to a work test technology.

There is known, for example, a test apparatus disclosed in PTL 1 as this type of technology. PTL 1 discloses the following. Specifically speaking, the test apparatus performs a primary judgment to judge whether the quality of tube glass is good or not, based on a comparison between a test image of the tube glass and a threshold value. If it is determined by the primary judgment that the tube glass is defective, the test apparatus performs a secondary judgment to classify a defect type by cutting out a defect image (an image of a portion where the relevant defect is captured) from the test image and inputting the defect image to a learning model. Then, the test apparatus re-judges whether the quality of the tube glass is good or not, based on a comparison between the test image and a threshold value according to the classified defect type.

PTL 1: Japanese Patent Application Laid-Open (Kokai) Publication No. 2020-85774

### SUMMARY

One of defects of a work is a crack(s). Regarding testing of the work, there is a demand for reduction of excessive detection of the cracks.

However, the technology disclosed in PTL 1 hardly reduces the excessive detection of the cracks. The reason for this is as described below.

Specifically speaking, the image which is input to the learning model is an image of the portion where the relevant defect is captured, that is, an image in which the entire defect is captured. Therefore, if the defect is a crack, an image of the entire crack is input to the learning model.

However, it is difficult to cause the learning model to perform learning to a degree enabling it to judge, with good accuracy, that the defect type is the crack(s). One of the reasons for such difficulty is that the crack(s) has various lengths and the image in which the relevant crack is captured may possibly become a wide-range image. With the wide-range image, an area in which the crack is not captured may be sometimes wider than an area in which the crack is captured. So, features of the crack are small and, as a result, the accuracy of the learning model degrades. Furthermore, there is a possibility that defects other than the crack (such as powder attached) may be captured in the area where the crack is not captured; and, therefore, if the defect(s) other than the crack is captured, together with the crack, in one image, the features of the crack become inaccurate and, as a result, the accuracy of the learning model degrades.

Because of the reasons described above, it is difficult to cause the learning model to learn the defect(s) with good accuracy. Therefore, there is a possibility that even if an image of any defect other than the crack(s) is input to the image, the excessive detection may be performed to detect that the defect type is the crack(s). Moreover, the above-described problem may possibly occur also with respect to a defect(s) of a specified type different from the crack(s) (a one-dimensional defect(s) of a specified type in the work), for example, a sliver(s) (typically a scratch(es)) that is a two-dimensional defect of a specified type in the work.

The test apparatus judges the type of each of a plurality of fragment images by inputting the plurality of fragment images, which are extracted from a test image of the work, to the learning model which receives an image(s) as input and outputs a type(s). The test apparatus judges whether a defect of a specified defect type is captured in the test image or not, on the basis of whether the judged type of each of the plurality of fragment images is the specified defect type or not.

Since the images which are input to the learning model are the fragment images, the learning model with high judgment accuracy can be prepared according to the present invention and, therefore, it is possible to reduce the excessive detections of the defect(s) of the specified defect type in the work.

### BRIEF DESCRIPTION OF THE DRAWINGS

FIG. 1 schematically illustrates the configuration of a test system according to a first embodiment of the present invention.

FIG. 2 illustrates the configuration of a control device.

FIG. 3 illustrates processing executed by an image processing unit.

FIG. 4 illustrates processing executed by an individual judgment unit.

FIG. 5 schematically illustrates learning of a deep learning model.

FIG. 6 illustrates processing executed by an entire judgment unit.

FIG. 7 illustrates one example of a test result screen.

FIG. 8 schematically illustrates processing executed by a model management unit.

FIG. 9A illustrates a first example of fragment image extraction.

FIG. 9B illustrates a second example of the fragment image extraction.

FIG. 9C illustrates a third example of the fragment image extraction.

FIG. 10 illustrates the outline of a flow of processing performed by a test apparatus according to a second embodiment of the present invention.

FIG. 11 illustrates entire judgment processing for slivers.

FIG. 12 illustrates entire judgment processing for small holes.

FIG. 13 illustrates a flow of learning processing performed by a model management unit according to a third embodiment of the present invention.

### DESCRIPTION OF EMBODIMENTS

In the description indicated below, an “interface apparatus” may be one or more interface devices. The one or more interface devices may be at least one of the following:
One or more I/O (Input/Output) interface devices. The I/O (Input/Output) interface device is an interface device for at least one of an I/O device and a remote display computer. The I/O interface device for the display computer may be a communication interface device. At least one I/O device may be a user interface device, for example, either one of input devices such as a keyboard and a pointing device, and output devices such as a display device.
One or more communication interface devices. The one or more communication interface devices may be one or more communication interface devices of the same type (for example, one or more NICs [Network Interface Cards]) or two or more communication interface devices of different types (for example, an NIC and an HBA [Host Bus Adapter]).

Furthermore, in the description indicated below, a “memory” is one or more memory devices, which are one example of one or more storage devices, and may typically be a main storage device. At least one memory device in the memory may be a volatile memory device or a nonvolatile memory device.

Furthermore, in the description indicated below, a “persistent storage apparatus” may be one or more persistent storage devices which are one example of one or more storage devices. The persistent storage device may be typically a nonvolatile storage device (such as an auxiliary storage device) and may be specifically, for example, an HDD (Hard Disk Drive), an SSD (Solid State Drive), an NVME (Non-Volatile Memory Express) drive, or an SCM (Storage Class Memory).

Furthermore, in the description indicated below, a “storage device” may be a memory and at least a memory for the persistent storage apparatus.

Furthermore, in the description indicated below, a “processor” may be one or more processor devices. At least one processor device may be typically a microprocessor device like a CPU (Central Processing Unit), but may be a processor device of a different type like a GPU (Graphics Processing Unit). At least one processor device may be of a single-core type or a multi-core type. At least one processor device may be a processor core. At least one processor device may be a processor device in a broad sense such as a circuit which is an aggregate of gate arrays by means of hardware description languages for performing a part or whole of processing (such as an FPGA [Field-Programmable Gate Array], CPLD [Complex Programmable Logic Device], or ASIC [Application Specific Integrated Circuit]).

Furthermore, in the description indicated below, a function may be sometimes described by an expression like “yyy unit”; however, the function may be implemented by execution of one or more computer programs by a processor, or may be implemented by one or more hardware circuits (such as FPGA or ASIC), or may be implemented by a combination of the above. If the function is implemented by the execution of a program by the processor, specified processing is performed by using, for example, storage devices and/or interface devices as appropriate and, therefore, the function may be considered as at least part of the processor. The processing explained by referring to the function as a subject may be the processing executed by the processor or an apparatus which has that processor. The program may be installed from a program source. The program source may be, for example, a program distribution computer or a computer-readable recording medium (such as a non-transitory recording medium). An explanation of each function is one example and a plurality of functions may be gathered as one function or one function may be divided into a plurality of functions.

Some embodiments of the present invention will be explained below with reference to the drawings.

### First Embodiment

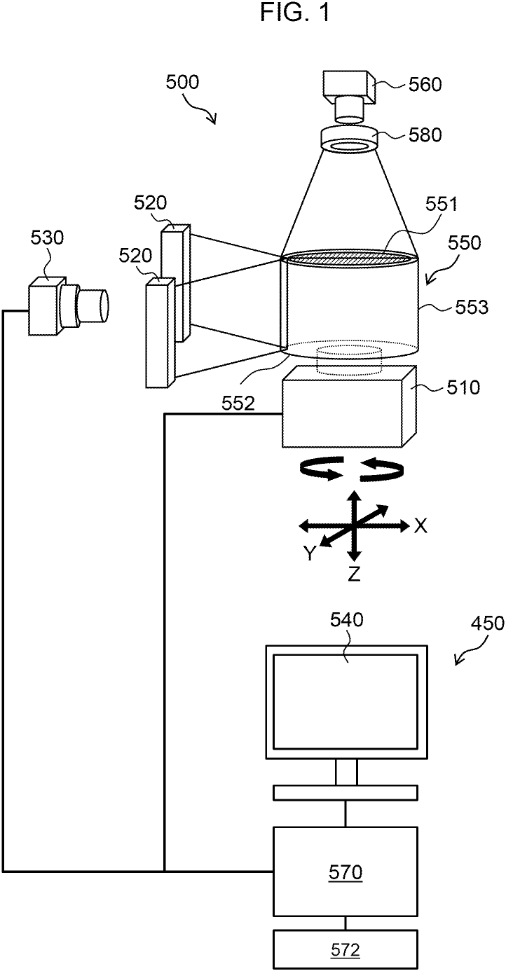

FIG. 1 schematically illustrates the configuration of a test system 500 according to a first embodiment of the present invention.

The test system 500 includes a rotating stage 510, a pair of line illuminators 520, a line sensor camera 530, an area camera 560, a ring illuminator 580, and a test apparatus 450.

The rotating stage 510 is a stage on which a cylindrical honeycomb structure 550 made of ceramics is to be mounted. The cylindrical honeycomb structure 550 has a top face 551 (a first bottom face), a bottom face 552 (a second bottom face) and a side face 553. The cylindrical honeycomb structure 550 (particularly, the side face 553) is one example of a work. The rotating stage 510 is movable in X-, Y-, and Z-directions and is capable of rotating the cylindrical honeycomb structure 550 about a rotational axis (parallel to the height direction (Z-direction) of the cylindrical honeycomb structure 550).

The line illuminators 520 are illuminators for projecting light onto the side face 553 (an outer circumferential face) of the cylindrical honeycomb structure 550. The line illuminators 520 are located on the right and left sides of a linear image capture range at the side face 553, which is placed between them, along the Y-direction. The length (height) of the linear image capture range may be the same as the height of the side face 553.

The line sensor camera 530 captures images of light reflected from the side face 553 of the cylindrical honeycomb structure 550.

The area camera 560 captures images of the top face 551 of the cylindrical honeycomb structure 550 mounted on the rotating stage 510.

The ring illuminator 580 is an illuminator capable of projecting light from above onto the top face 551of the cylindrical honeycomb structure 550 mounted on the rotating stage 510.

The test apparatus 450 may be a computer like a personal computer and includes an input device 572, a display device 540, and a control device 570 connected to them. The input device 572 and the display device 540 may be integrated together like a touch panel.

An image(s) of the side face 553 of the rotating cylindrical honeycomb structure 550, which is captured by the line sensor camera 530, is input from the line sensor camera 530 into the control device 570. As linear captured images are aligned along the Y-direction (which is a direction perpendicular to an image capture direction and the height direction (the Z-direction) of the line sensor camera 530), a two-dimensional captured image is obtained. If there is a crack(s) in the side face 553 of the cylindrical honeycomb structure 550, the control device 570 detects the crack(s).

The light projected by the pair of line illuminators 520 may be of different colors; however, in this embodiment, the pair of line illuminators 520 project the light of the same color onto a linear image capture range. Furthermore, the line sensor camera 530 may be a color line sensor camera; however, in this embodiment, it is a monochrome line sensor camera. The line sensor camera 530 has high resolving power and sensitivity. Therefore, there is a concern about excessive detection of cracks, but the test apparatus 450 according to this embodiment reduces the excessive detection of the cracks.

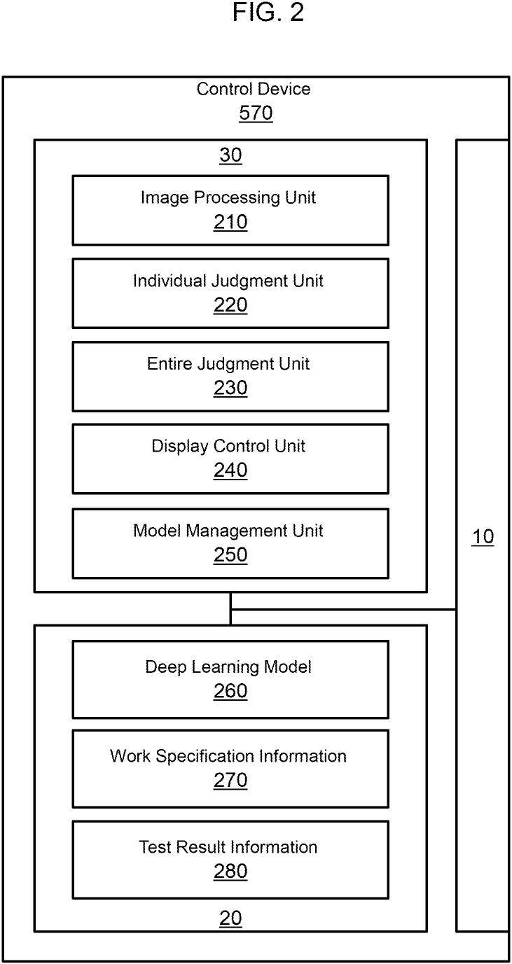

FIG. 2 illustrates the configuration of the control device 570.

The control device 570 has an interface apparatus 10, a storage apparatus 20, and a processor 30 connected to them.

The interface apparatus 10 is connected to the input device 572, the display device 540, and the line sensor camera 530 to enable communication between them.

The storage apparatus 20 stores computer programs and information. For example, the storage apparatus 20 stores a deep learning model 260, work specification information 270, and test result information 280.

The deep learning model 260 is one example of learning models and receives an image(s) as input and outputs a defect type(s). The deep learning model 260 is typically a neural network. The deep learning model 260 is used for learning and inference by an individual judgment unit 220 described later.

The work specification information 270 is information indicating work specifications for each customer. The “customer(s)” is a destination to provide the cylindrical honeycomb structure 550. Regarding each customer, the “work specifications” are specifications of the cylindrical honeycomb structure 550 and include conditions for what is considered to be a crack(s) (particularly, a crack length condition).

The test result information 280 is information indicating test results of each cylindrical honeycomb structure 550. The test results may include whether any defect exists or not, the type of the detected defect, and a test image in which the defect is captured. The test results may include the details of the results such as the position of the defect (for example, coordinates when a specified position in the side face 553 of the cylindrical honeycomb structure 550 is set as reference coordinates (origin)).

Functions such as an image processing unit 210, an individual judgment unit 220, an entire judgment unit 230, a display control unit 240, and a model management unit 250 are implemented by the processor 30 by executing computer programs stored in the storage apparatus 20. Furthermore, a control unit (which is not illustrated in the drawing) that controls various devices such as the rotating stage 510 and the line sensor camera 530 may be also implemented.

Processing executed by the functions 210, 220, 230, 240, and 250 will be explained below. Incidentally, in the following explanation, a vertical direction is synonymous with a longitudinal direction of linear captured images (the Z-direction) and a horizontal direction is synonymous with an aligned direction of the linear captured images (the Y-direction).

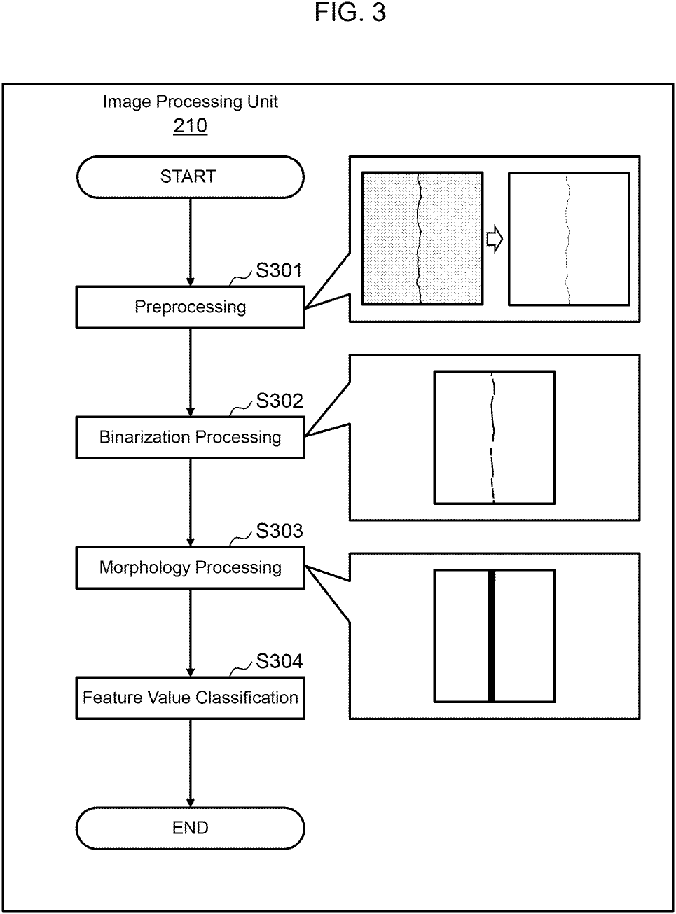

FIG. 3 illustrates the processing executed by the image processing unit 210.

The image processing unit 210 executes processing immediately preceding the processing to be executed by the individual judgment unit 220. The immediately preceding processing is processing for generating a test image to be input to the individual judgment unit 220. Specifically speaking, for example, the image processing unit 210 may cut out two-dimensional defect images from a two-dimensional captured image (an image composed of linear captured images arranged in the horizontal direction) and execute S301 to S304 described below with respect to each defect image. The “two-dimensional captured images” may be, for example, the required number of strip images to surround the outer circumference of the side face 553. The “defect image(s)” may be the entire two-dimensional captured image or an image which is extracted from the two-dimensional captured image and in which the entire one defect is captured. In other words, a defect image may exist for each defect and the horizontal and vertical size of the defect image may vary depending on the size of the relevant defect (for example, the size of the defect in the horizontal and vertical directions). In the following explanation, it is assumed that there is one defect captured in one defect image.

The image processing unit 210 removes noise components from a defect image(s) by applying filtering processing (smoothing processing) to the defect image(s) (S301). For example, with respect to a range of the defect which is long in the vertical direction, low-frequency components are removed in the horizontal direction and highfrequency components are removed in the vertical direction; and as a result, the range of the defect which is long in the vertical direction becomes clear.

Next, the image processing unit 210 executes binarization processing on the defect image to which the filtering processing has been applied (S302). Consequently, pixels with low luminance are extracted from the defect image.

Then, the image processing unit 210 executes morphology processing on the defect image to which the binarization processing has been applied (S303). In this morphology processing, expansion processing and coupling processing are executed on the pixels, which were extracted by the binarization processing in S302, in the longitudinal direction of the defect which is overlaid on the pixels. As a result, even if the pixels extracted by the binarization processing in S302 are intermittent in the longitudinal direction of the defect, they form one continuous defect. Therefore, if the defect is a crack(s) and the result of the binarization processing shows that the cracks are intermittent, they are extracted as one continuous crack by the morphology processing.

Lastly, the image processing unit 210 calculates feature values regarding various items (for example, roundness, coordinates, and an aspect ratio) from the defect image, to which the morphology processing has been applied, and classifies the type of the defect, which is captured in the defect image, into either cracks or non-cracks (other than the cracks) on the basis of the calculated various feature values.

Regarding the defect image(s) whose defect type is classified as the cracks, the entire defect image or a part of it is processed as a test image by the individual judgment unit 220. Regarding the defect image(s) whose defect type is classified as the non-cracks, the processing by the individual judgment unit 220 may be either executed or not executed.

It is hereinafter assumed that the test image to be input to the individual judgment unit 220 is the defect image or a part of it whose defect type is classified as the cracks by the image processing unit 210. Therefore, in the following explanation, it is assumed that the test image is an image obtained as a result of the processing (the processing including the morphology processing) executed on the defect image by the image processing unit 210, that is, an image in which the defect (target) detected as a crack(s) is captured. Accordingly, it is assumed that the defect captured in the test image is a crack(s). Incidentally, even if the cracks captured in the test image are actually intermittent, they may possibly be a continuous crack by means of the aforementioned morphology processing.

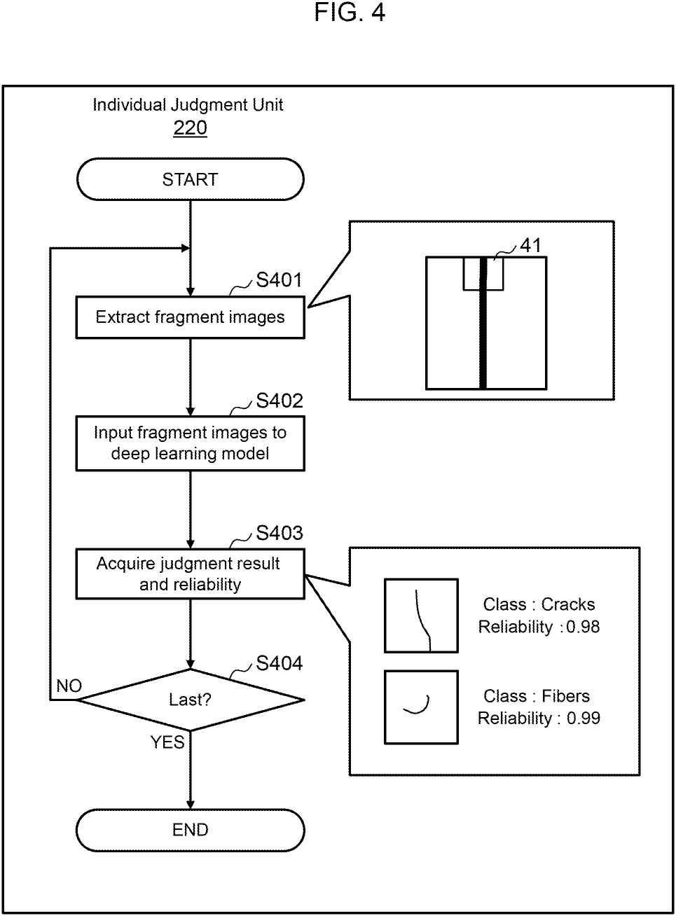

FIG. 4 illustrates processing executed by the individual judgment unit 220.

The individual judgment unit 220 extracts fragment images from a range which has not been obtained as fragment images, within a crack range (S401). The “crack range” is an image range where the crack(s) is captured in the test image; and it may be the whole area or a part of the test image. The “fragment image(s)” is an image in which a crack (strictly speaking, a part of the crack) is captured, and is typically a square image (see the reference numeral 41 in FIG. 4). A fragment image may be, for example, an image with 200 pixels horizontally and vertically. Also, fragment images may be extracted in a specified sequential order (for example, sequentially from the top of the crack range to its end).

The individual judgment unit 220 performs inference to judge whether the type of the defect captured in the fragment image is a crack or not. Specifically speaking, the individual judgment unit 220 inputs a fragment image(s), which was extracted in S401, into the deep learning model 260 (S402) and obtains a judgment result regarding the relevant fragment image (the judged defect type (class)) and reliability (reliability of the judgment) from the deep learning model 260 (S403).

If the fragment image acquired in S401 is the last fragment image which can be extracted from the crack range (S404: YES), in other words, if all the fragment images have been acquired from the crack range, the processing terminates. On the other hand, if any range which has not been acquired as a fragment image(s) remains in the crack range (S404: YES), the processing returns to S401.

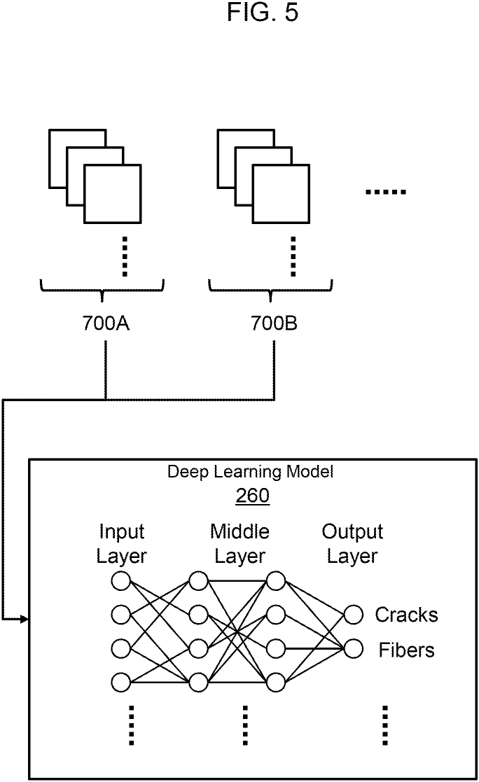

The defect type is judged with respect to each fragment image extracted from the crack range by inputting the fragment image to the deep learning model 260 as described above. Incidentally, the deep learning model 260 has already performed learning by using teacher data for each defect type (for example, teacher data 700A as a plurality of fragment images whose defect types should be judged to be cracks, and teacher data 700B as a plurality of fragment images whose defect types should be judged to be fibers) as illustrated in FIG. 5. The defect type(s) for which the teacher data are prepared as the defect type other than the cracks may be at least one of powder attached, molded scratches, dirt, and so on instead of or in addition to the fibers. Specifically speaking, the output from the deep learning model 260 may be the cracks or any one of a plurality of defect types other than the cracks. The teacher data may be prepared for the defect type(s) which is specific to the work made of ceramics, and learning of the deep learning model 260 may be performed by the individual judgment unit 220 in order to enable the judgment of that defect type.

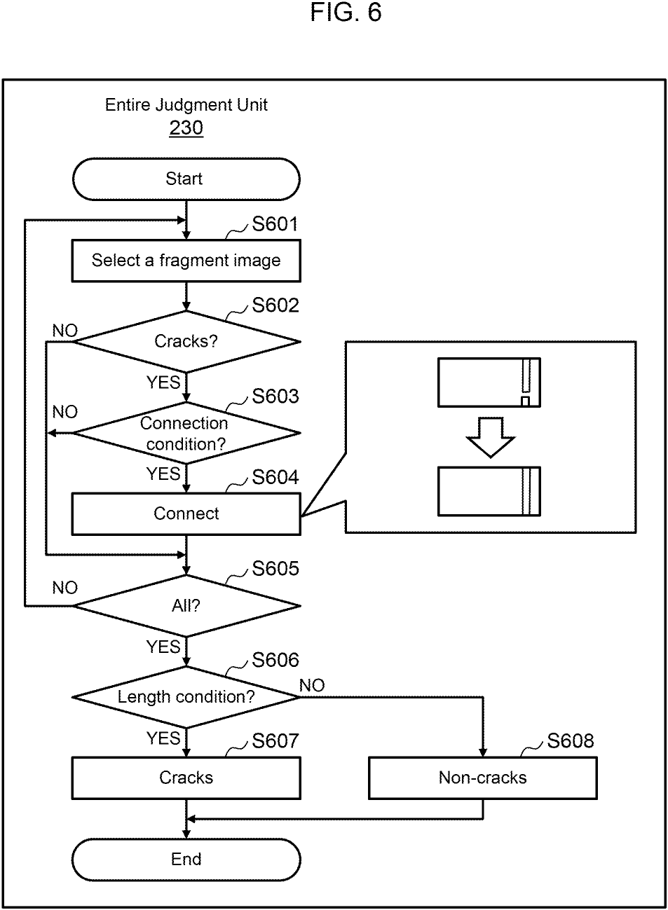

FIG. 6 illustrates processing executed by the entire judgment unit 230. In the following explanation, a fragment image(s) whose defect type is judged to be a crack(s) will be referred to as a “crack fragment image(s)” and a fragment image(s) whose defect type is judged to be of any one of the types other than the crack(s) will be referred to as a “non-crack fragment image(s).”

The entire judgment unit 230 selects one unselected fragment image from among the fragment images whose defect types have been judged by the individual judgment unit 220 (S601). The fragment image may be selected in a specified sequential order (for example, sequentially from the top of the crack range to its end).

The entire judgment unit 230 judges whether the fragment image selected in S601 is a crack fragment image or not (S602). If the judgment result in S602 is false (S602: NO), the processing proceeds to S605.

If the judgment result in S602 is true (S602: YES), the entire judgment unit 230 judges whether the distance between the crack fragment image selected in S601 and a crack fragment image which is closest to the above-selected crack fragment image and has already been selected (the crack fragment image which was selected in the past in S601) satisfies a connection condition or not (S603). The “connection condition” means an allowable distance between the crack fragment images. That distance may be expressed with the number of pixels or the number of fragment images. If the distance between the crack fragment images is zero, the crack fragment images are adjacent to each other.

If the judgment result in S603 is true (S603: YES), the entire judgment unit 230 connects the crack fragment images together (S604). Specifically speaking, for example, if one or more non-crack fragment images exist between the crack fragment images as illustrated in the drawing, the entire judgment unit 230 changes the judgment result of each of the one or more non-crack fragment images (the attribute of the fragment image) from non-cracks (other than the cracks) to the cracks. As a result, all the images between the crack fragment images become crack fragment images and, therefore, the plurality of crack fragment images are aligned continuously without being interrupted by the non-crack fragment images.

In the case of “NO” in S602 or after S604, the entire judgment unit 230 judges whether all the fragment images within the crack range have been selected or not (S605). If the judgment result in S605 is false (S605: NO), the processing returns to S601.

If the judgment result in S605 is true (S605: YES), the entire judgment unit 230 judges whether the crack length satisfies its condition or not (S606). Specifically speaking, the entire judgment unit 230 identifies, from the work specification information 270, work specifications corresponding to the relevant customer of the cylindrical honeycomb structure 550 corresponding to the test image. The entire judgment unit 230 judges whether or not the crack length condition indicated by the identified work specifications is satisfied by the crack length (the length according to the crack fragment images which are aligned continuously without being interrupted by the non-crack fragment images). The crack length condition is a condition for the length to be recognized as a crack. The crack length may be expressed in SI units (for example, in mm (millimeters)) or may be expressed as the number of fragment images or pixels.

If the judgment result in S606 is true (S606: YES), the entire judgment unit 230 judges that the defect type of the test image is the crack(s) (S607). In other words, it is judged that the detection result (classification result) by the image processing unit 210 is correct.

On the other hand, if the judgment result in S606 is false (S606: NO), the entire judgment unit 230 judges that the defect type of the test image is the non-crack(s) (S608). In other words, it is judged that the detection result by the image processing unit 210 is false (excessive detection). Incidentally, in the case of “NO” in S606, the judgment of the non-cracks may include the judgment of whether or not the defect is of any type other than the cracks. For example, if the number of the fragment images which are judged to be the “powder attached” is the largest among all the fragment images extracted from the crack range (and if a ratio of the fragment images which are judged to be the “powder attached” to all the fragment images extracted from the crack range is equal to or higher than a specified ratio), the defect type may be judged to be the “powder attached.”

A work ID of the cylindrical honeycomb structure 550 may be input, together with the defect image, to the image processing unit 210. The work ID may be passed down from the image processing unit 210 to the individual judgment unit 220 and then from the individual judgment unit 220 to the entire judgment unit 230 in accordance with a flow of the processing. Information indicating the detection result (classification result) by the image processing unit 210, information indicating the judgment result (and its reliability) for each fragment image by the individual judgment unit 220, and information indicating the judgment result by the entire judgment unit 230 may be stored in the test result information 280 and be associated with the work ID. The display control unit 240 displays a test result screen on the display device 540 on the basis of the test result information 280.

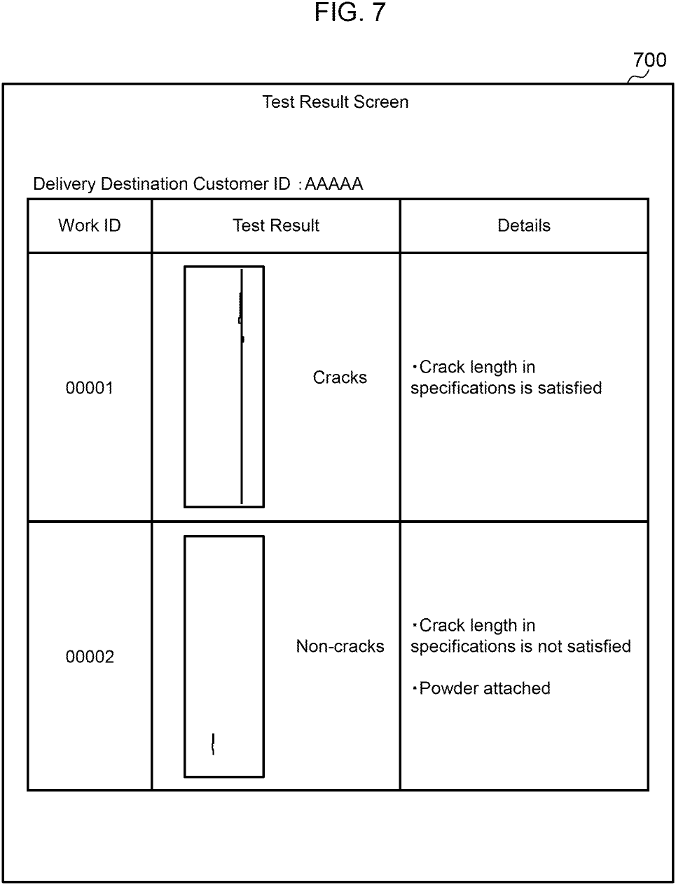

FIG. 7 illustrates one example of the test result screen 700.

The test result screen 700 is typically a GUI (Graphical User Interface). For example, the following information is displayed on the test result screen 700:
(A) A customer ID of a customer designated by an operator (for example, an administrator); and
(B) the work ID, a test result, and the details of each work (the cylindrical honeycomb structure 550) regarding which whether the crack length satisfies the condition or not is judged on the basis of the work specifications corresponding to the relevant customer ID.

The test result in (B) is either one of the detection result (classification result) by the image processing unit 210 and the judgment result by the entire judgment unit 230.

The details in (B) include the reason why the test result in (B) was obtained. Furthermore, if the test result in (B) is the non-crack(s), the details in (B) include which type the relevant defect is.

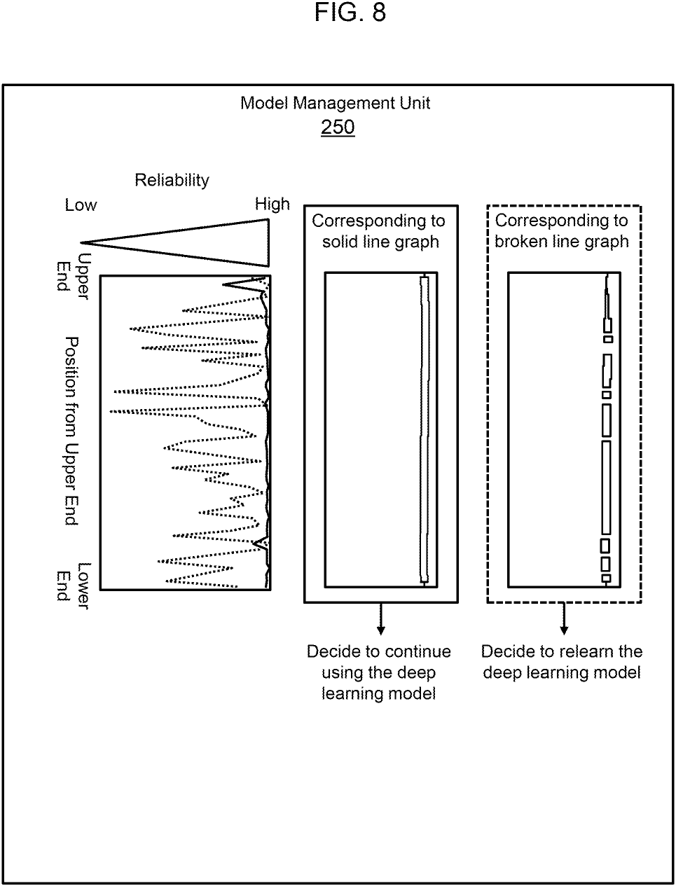

FIG. 8 schematically illustrates processing executed by the model management unit 250.

The model management unit 250 judges whether to continue using the deep learning model 260 or not, on the basis of the reliability of each of the plurality of fragment images (the reliability of the judgment result). Accordingly, if data drift occurs, that data drift is detected and the continuous use of the deep learning model 260 is stopped, so that it is possible to maintain the reliability of the test apparatus 450, for example, as described below.

Specifically speaking, let us assume that a crack which continues from an upper end (top) of the vertically long crack range to its lower end (end) is obtained by the morphology processing.

If no data drift has occurred, it is judged as illustrated with a solid line graph that any one of the fragment images is a crack fragment image; and the reliability of the judgment result of each fragment image is high.

On the other hand, if the data drift has occurred, it is judged as illustrated with a broken line graph that some of the fragment images which should be judged to be the crack fragment images are non-crack fragment images; and even if the fragment images are judged to be crack fragment images (that is, even if the judgment result is correct), the reliability of the judgment result may be low. The model management unit 250 can stop continuing to use such deep learning model 260.

The above-described embodiment can be, for example, summarized as described below. The following summary may include a supplementary explanation of the aforementioned explanation and an explanation of variations.

The individual judgment unit 220 for the test apparatus 450 inputs each of a plurality of fragment images, which are extracted from the test image, into the deep learning model 260 and thereby judges the type regarding each of the plurality of fragment images. The entire judgment unit 230 for the test apparatus 450 judges whether a crack(s) is captured in the test image or not, on the basis of whether the judged type of each of the plurality of fragment images is the crack(s) or not.

Since the image which is input to the deep learning model 260 is a fragment image which is smaller than the entire test image, it is possible to prepare the learning model with high judgment accuracy and thereby expect the excessive detection to be reduced. For example, In the aforementioned embodiment, the crack detection (the judgment result based on the result of the feature value classification) by the image processing unit 210 may possibly be the excessive detection, but the excessive detection of the cracks can be reduced by the individual judgment unit 220 and the entire judgment unit 230 in the latter part of the embodiment.

One possible method for reducing the excessive detection may be to adopt filtering processing with high computational load by executing processing by using a bilateral filter on the test image instead of using the deep learning model 260. However, since the computational load of the processing is high, it requires long time for testing. Regarding the aforementioned embodiment, the filtering processing in the former part of the embodiment may be processing with low computational load such as smoothing processing by adopting the processing using the deep learning model 260 in the latter part of the embodiment; and, as a result, a reduction in testing time can be expected while securing the test accuracy.

Other types of learning models, for example, a decision tree may be adopted instead of the deep learning model 260. However, it is difficult for other types of learning models to achieve high accuracy in the inference by inputting an image(s). The deep learning model 260 is suited for the inference by inputting the image(s), so that the inference with high accuracy can be expected.

Furthermore, the deep learning model 260 is a so-called black-box-type model. Specifically speaking, even if the type of the input fragment image is judged (or output), the reason for the judgment is not output. In other words, there is no explainability. Therefore, the explainability cannot be given to the judgment result regarding the test image to explain that the image which is input to the deep learning model 260 is the test image. In this embodiment, the type of each fragment image is judged by the individual judgment unit 220 and then whether a crack(s) is captured in the test image or not (specifically speaking, for example, if any defect is captured in the test image, the type of the defect) is judged by the entire judgment unit 230 on the basis of the judgment result of each fragment image. Therefore, it is possible to achieve both the high accuracy regarding the inference by inputting the image(s), and the explainability of the judgment result regarding the test image (for example, to explain that the relevant image is judged (or is not judge) to be the crack(s) because the crack length satisfies the condition (or fails to satisfy the condition).

The test image may be an image which captures the entire area of the work (for example, the side face 553 of the cylindrical honeycomb structure 550), or may be a defect image of a part of that captured image which is identified by a specified method (for example, a rule-based judgment) (an image of the range where the relevant defect is captured). The defect image may be an image as the aforementioned crack range or may be a wide-range image including the crack range (one example of a defect range which is the range where the defect is captured).

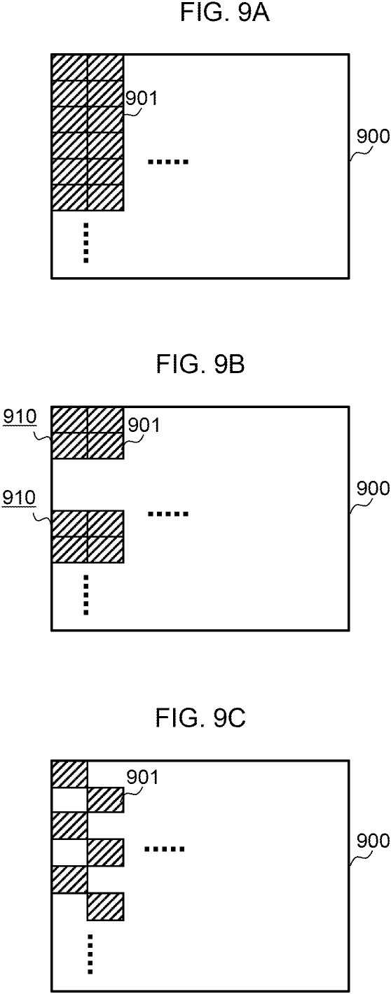

A plurality of fragment images may be extracted from the test image by the individual judgment unit 220. Examples of the extraction of the fragment images may be any one of the following (it should be noted that a fragment image may be typically a square or a rectangle).
The individual judgment unit 220 extracts fragment images 901 from a test image 900 as illustrated in FIG. 9A so that no gaps will be formed between the fragment images 901. The entire area or a part of the test image 900 is the crack range. In other words, in the example illustrated in FIG. 9A, the fragment images 901 may be extracted from a range other than the crack range. Also, which range in the test image 900 is the crack range does not have to be identified by the image processing unit 210.
The individual judgment unit 220 extracts the fragment images 901 from only crack ranges 910 in the test image 900 as illustrated in FIG. 9B so that no gaps will be formed between the fragment images 901. The cracks may be discontinuous and intermittent in their longitudinal direction or a plurality of cracks may possibly be aligned. In such cases, the test image 900 is mainly classified into one or a plurality of crack ranges 910 and a range other than the crack ranges 910. The individual judgment unit 220 extracts the fragment image 901 from only the crack ranges 910 as illustrated in FIG. 9B. Incidentally, regarding each crack range 910, an image of the entire area of the relevant crack range 910 may be recognized as the test image 900.
The individual judgment unit 220 may extract the fragment images 901 at arbitrary positions or specified positions in the test image 900, as illustrated in FIG. 9C, and any gap with arbitrary or specified length may be formed between the fragment images 901. The length of the gap may be the same as the length of the fragment image (the length of the fragment image in its aligned direction) or may be shorter or longer than the length of the fragment image (for example, n times of the fragment length (n is a natural number)). Also, the fragment image may be extracted from the range other than the crack range(s) or may be extracted from only the crack range(s).

If the crack length identified from one or a plurality of crack fragment images satisfies the crack length condition, the entire judgment unit 230 may judge that a crack(s) is captured in the test image. The accuracy of the judgment result regarding each fragment image is high, so that it is possible to reduce the excessive detection of the cracks.

For example, if the shortest crack length which satisfies the crack length condition is the same as or shorter than the crack length indicated by one crack fragment image and if there is at least one crack fragment image, it will be judged that a crack(s) is captured in the test image.

If the crack length identified from consecutive two or more crack fragment images (for example, the longitudinal-direction length of a range constituted by the consecutive two or more crack fragment images (the length of the crack fragment images along their aligned direction)) satisfies the crack length condition, the entire judgment unit 230 may judge that a crack(s) is captured in the test image. Accordingly, it is possible to reduce the excessive detection of the cracks.

If there is a distance between the crack fragment images and that distance is less than an allowable distance, the entire judgment unit 230 may recognize the distance as a part of the crack (crack length). Consequently, the crack(s) can be detected with good accuracy. For example, if one or more non-crack fragment images exist between the crack fragment images as a result of the fragment image extraction as illustrated in FIG. 9A or FIG. 9B, but if the distance between the crack fragment images is less than the allowable distance, the entire judgment unit 230 may change the judgment result of the relevant fragment image, regarding each of the one or more non-crack fragment images, to the crack(s). Accordingly, even if some of the fragment images are mistakenly judged to be the non-crack(s) due to some reason such as degradation of the reliability of the deep learning model 260, it is possible to detect the crack(s). Furthermore, for example, if there is a gap between two consecutive crack fragment images (between a crack fragment image and its successive crack fragment image) as a result of the fragment image extraction illustrated in FIG. 9C and the distance of the gap is less than the allowable distance, the entire judgment unit 230 may recognize the distance of the gap as a part of the crack length.

The display control unit 240 displays the test results on the basis of the test result information 280 including the information indicating the result of the judgment by the entire judgment unit 230. The test results may be displayed on the display device 540 included in the test apparatus 450 or may be displayed on a remote computer connected to the test apparatus 450 (for example, a server). The displayed test results include (a) the judgment result indicating whether or not a crack(s) is captured in the aforementioned test image, and (b) whether the aforementioned crack length condition is satisfied or not, and may include a reason for the judgment result (a). Consequently, the judgment result for which the deep learning model 260 that is a black-box-type model is used can be displayed together with the reason (explanation) for the judgment result.

The crack length condition may be a condition defined in the work specifications corresponding to the relevant customer of the cylindrical honeycomb structure 550 among the work specifications defined for each customer. If the crack length condition varies depending on the customers, the teacher data and the learning are required for each customer when the image input to the deep learning model 260 is a test image (for example, an image in which the entire crack is captured). According to the aforementioned embodiment, the crack length condition which is compared with the crack length identified from the continuous crack fragment image varies depending on the customers and the same judgment will be made with respect to each fragment image regardless of the customers. Therefore, it is possible to make the teacher data and the learning commonly used regardless of the customers, which is highly convenient.

The model management unit 250 may judge whether or not to continue using the deep learning model 260, on the basis of the reliability obtained from the deep learning model 260 with respect to the judgment result of each of the plurality of fragment images. Consequently, if any data drift has occurred, the data drift is detected and the continuous use of the deep learning model 260 regarding which the reliability has degraded is stopped, so that it is possible to maintain the reliability of the test apparatus 450.

### Second Embodiment

A second embodiment of the present invention will be explained. When doing so, differences from the first embodiment will be mainly explained and an explanation about any content in common with the first embodiment will be omitted or simplified.

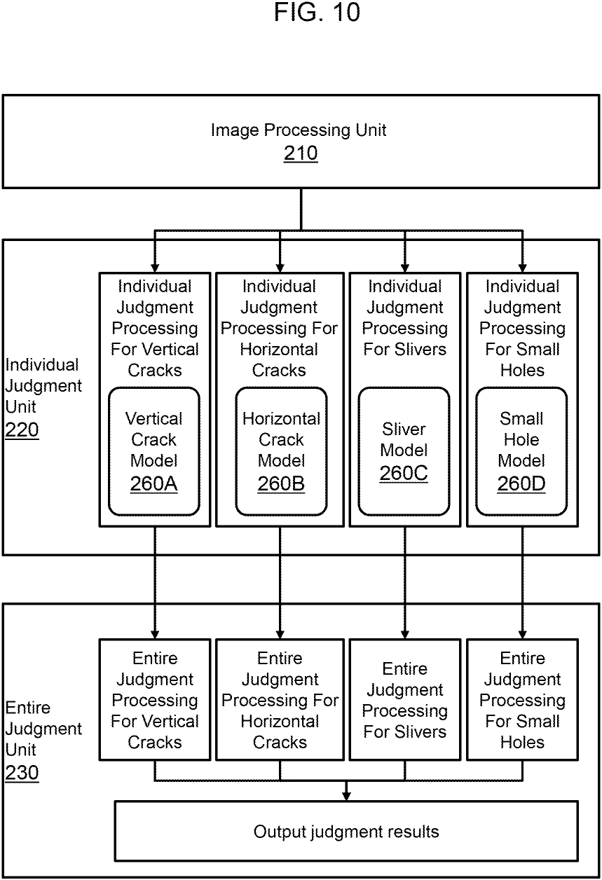

FIG. 10 illustrates the outline of a flow of processing performed by a test apparatus 450 according to the second embodiment.

Other defect types such as a sliver(s) or a small hole(s) can be adopted as a specified defect type(s) instead of or in addition to a crack(s). Also, the crack(s) is a vertical crack(s) in the first embodiment, but a horizontal crack(s) is adopted in addition to (or instead of) the vertical crack(s). In other words, the “crack(s)” may be the vertical crack(s), the horizontal crack(s), or an all-inclusive term for these cracks.

In this embodiment, the vertical crack(s), the horizontal crack(s), the sliver(s), and the small hole(s) are adopted as a plurality of defect types.

Regarding each of a plurality of defect types, there is a learning model corresponding to the relevant defect type. Specifically speaking, for example, there are a vertical crack model 260A which is a learning model for vertical cracks, a horizontal vertical crack model 260B which is a learning model for horizontal cracks, a sliver model 260C which is a learning model for slivers, and a small hole model 260D which is a learning model for small holes. Any one of the models 260A to 260D is, for example, a deep learning model (typically a neural network).

Regarding each of the plurality of defect types, the individual judgment unit 220 inputs each of a plurality of fragment images, which are extracted from a test image, into a learning model corresponding to the relevant defect type and thereby judges the type of the relevant fragment image with respect to each of the plurality of fragment images. The entire judgment unit 230 judges whether a defect corresponding to the relevant defect type is captured in the test image or not, on the basis of whether the type judged with respect to each of the plurality of fragment images corresponds to the relevant defect type or not. As a result, a reduction of excessive detections of various defects in the work (the side face 553 of the cylindrical honeycomb structure 550 in this embodiment) can be expected.

As illustrated in FIG. 10, the image processing unit 210 generates a test image to be input to the individual judgment unit 220 and inputs this test image to the individual judgment unit 220. The test image may be used commonly for four individual judgment processing sequences described later (individual judgment processing for vertical cracks, individual judgment processing for horizontal cracks, individual judgment processing for slivers, and individual judgment processing for small holes) or may be prepared separately for the respective individual judgment processing sequences. Moreover, test images may be prepared separately for the respective individual judgment processing sequences and the respective test images which are prepared separately for the respective individual judgment processing sequences may be used in the four individual judgment processing sequences, respectively.

Furthermore, when the test images are prepared separately for the respective individual judgment processing sequences, the image processing unit 210 may perform filtering processing, binarization processing, or morphology processing corresponding to the relevant individual judgment processing (defect type) with respect to each individual judgment processing sequence. The image processing unit 210 may classify images to which the morphology processing has been applied, into any one of the defect types by a specified means such as a rule-based means. The test image(s) associated with the defect type(s) may be used for the four individual judgment processing sequences.

The individual judgment unit 220 performs the individual judgment processing sequences for the respective defect types, that is, the four individual judgment processing sequences in this embodiment. The four individual judgment processing sequences are performed in parallel with each other, but two or more individual judgment processing sequences among them may be performed sequentially. Moreover, a test image is used commonly for the four individual judgment processing sequences. Not only the flow of the individual judgment processing for vertical cracks, but also any other flows of the individual judgment processing sequences may be similar to the flow illustrated in FIG. 4. Specifically, a fragment image(s) is/are acquired from a test image and the fragment image(s) is/are input to the learning model 260, so that the defect type of the relevant fragment image may be judged. Regarding a plurality of extracted fragment images, the fragment images may partly overlap with each other (the same applies in the first embodiment).

Regarding the individual judgment processing for vertical cracks, each fragment image is either a vertical crack fragment image (a fragment image which is classified as a vertical crack) or a non-vertical crack fragment image (a fragment image which is classified as those other than the vertical crack). Regarding the individual judgment processing for horizontal cracks, each fragment image is either a horizontal crack fragment image (a fragment image which is classified as a horizontal crack) or a non-horizontal crack fragment image (a fragment image which is classified as those other than the horizontal crack). Regarding the individual judgment processing for slivers, each fragment image is either a sliver fragment image (a fragment image which is classified as a sliver) or a non-sliver fragment image (a fragment image which is classified as those other than the sliver). Regarding the individual judgment processing for small holes, each fragment image is either a small hole fragment image (a fragment image which is classified as a small hole) or a non-small hole fragment image (a fragment image which is classified as those other than the small hole).

The entire judgment unit 230 performs the entire judgment processing sequences for the respective defect types, that is, four entire judgment processing sequences in this embodiment (entire judgment processing for vertical cracks, entire judgment processing for horizontal cracks, entire judgment processing for slivers, and entire judgment processing for small holes). The four entire judgment processing sequences are performed in parallel with each other, but two or more entire judgment processing sequences among them may be performed sequentially.

The flow of the entire judgment processing for vertical cracks is as illustrated in FIG. 6. Also, the flow of the entire judgment processing for horizontal cracks is as illustrated in FIG. 6. Specifically speaking, for example, the following explanation can be adopted as an explanation about the entire judgment processing for horizontal cracks by replacing a “vertical direction” and a “vertical crack” regarding the explanation about the entire judgment processing for vertical cracks with a “horizontal direction” and a “horizontal crack” (the “vertical direction” and the “horizontal direction” are examples of a “one-dimensional direction”).
If a horizontal crack length identified from one or a plurality of horizontal crack fragment images aligned in the horizontal direction satisfies a horizontal crack length condition which is a condition regarding the length (S606: YES), the entire judgment unit 230 judges that a horizontal crack is captured in the test image. For example, if the horizontal crack length identified from two or more horizontal crack fragment images which are consecutive in the horizontal direction satisfies the horizontal crack length condition, the entire judgment unit 230 judges that a horizontal crack is captured in the test image.
If there is a distance between horizontal crack fragment images and the distance is less than an allowable distance, the entire judgment unit 230 recognizes the distance as part of a horizontal crack. For example, if the distance between the horizontal crack fragment images is less than the allowable distance even when there is/are one or more non-horizontal crack fragment images between the horizontal crack fragment images, the entire judgment unit 230 changes the judgment result of the fragment image to a horizontal crack with respect to each of the one or more non-horizontal crack fragment images.

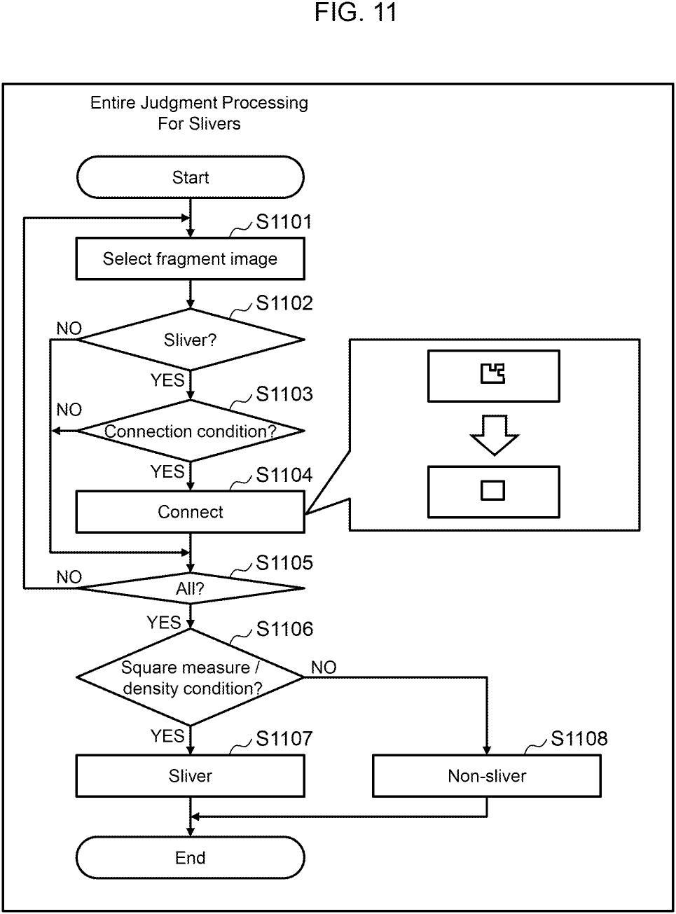

The flow of the entire judgment processing for sliver is as illustrated in FIG. 11. S1101 to S1108 correspond to S601 to S608 illustrated in FIG. 6 and the main difference between them is described below. Specifically, in S1102, the entire judgment unit 230 judges whether the fragment image selected in S1101 is a sliver fragment image or not. If the judgment result in S1102 is true, the entire judgment unit 230 judges in S1103 whether or not the distance between the sliver fragment image selected in S1101 and a sliver fragment image which is closest to the above-mentioned sliver fragment image and has already been selected (the sliver fragment image which was selected in S1101 in the past) satisfies a connection condition. The “connection condition” indicates an allowable distance in two-dimensional directions between the sliver fragment images (the above-described distance may be expressed by the number of pixels or the number of fragment images in the same manner as the distance between the crack fragment images). If the judgment result in S1103 is true, the entire judgment unit 230 connects the sliver fragment images together in S1104. Specifically speaking, for example, if there is/are one or more non-sliver fragment images between the sliver fragment images as illustrated in the drawing, the entire judgment unit 230 changes the judgment result of each of the one or more non-sliver fragment images (the attribute of the relevant fragment image) from the non-sliver to the sliver. As a result, all the fragment images between the sliver fragment images become sliver fragment images and, therefore, the plurality of sliver fragment images continue without being interrupted by any non-sliver fragment image. If there is a distance between the sliver fragment images and the distance is less than an allowable distance, the entire judgment unit 230 may recognize the distance as part of a sliver. If the distance between the sliver fragment images is less than the allowable distance even when there is/are one or more non-sliver fragment images between the sliver fragment images, the entire judgment unit 230 may change the judgment result of the relevant fragment image to the sliver with respect to each of the one or more non-sliver fragment images. In S1106, the entire judgment unit 230 judges whether or not a sliver’s square measure and/or a sliver’s density identified from one or a plurality of sliver fragment images aligned in two-dimensional directions satisfies a square measure / density condition (a condition regarding the square measure and/or the density). The “sliver’s square measure” is the square measure of the sliver and the “sliver’s density” is the density of the sliver. The square measure / density condition may be a condition identified from the work specification information 270 (for example, a condition based on work specifications corresponding to the customer). If the judgment result in S1106 is true, the entire judgment unit 230 judges in S1107 that the defect type of the test image is a sliver (judges that a sliver is captured in the test image).

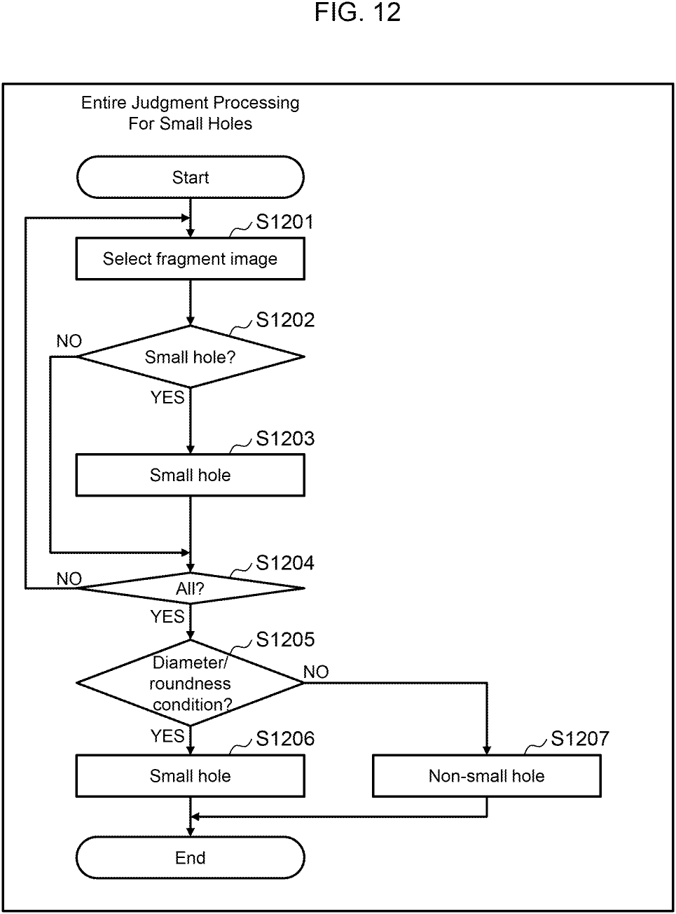

The flow of the entire judgment processing for small hole is as illustrated in FIG. 12. Specifically, the entire judgment unit 230 selects a fragment image from the test image (S1201) and judges whether the selected fragment image is a small hole fragment image or not (S1202). If the judgment result in S1202 is true (S1202: YES), the entire judgment unit 230 temporarily classifies the small hole fragment image selected in S1201 as a small hole (S1203) and judges whether all fragment images have been selected or not (S1204). If the judgment result in S1204 is true (S1204: YES), the entire judgment unit 230 judges whether or not a diameter and/or roundness identified from the small hole fragment image satisfies a diameter/roundness condition (a condition regarding the diameter and/or the roundness) (S1205). The diameter/roundness condition may be a condition identified from the work specification information 270 (for example, a condition based on the work specifications corresponding to the customer). If the judgment result in S1205 is true (S1205: YES), the entire judgment unit 230 judges that the defect type of the test image is a small hole (judges that a small hole is captured in the test image) (S1206). If the judgment result in S1205 is false (S1205: NO), the entire judgment unit 230 judges that the defect type of the test image is a non-small hole (S1207).

The entire judgment unit 230 may output the judgment result based on the results of the four entire judgment processing sequences. The display control unit 2340 may display a test result screen for test result information, including information indicating the judgment result, on the display device 540. The test result may include: the judgment result of whether or not the defect of the specified defect type is captured in the test image; and a reason for the above-mentioned judgment result, that is, a reason including whether or not a condition for judging that the defect of the specified defect type is captured is satisfied. The “specified defect type” may be a vertical crack(s), a horizontal crack(s), a sliver(s), and a small hole(s) and, particularly, may be at least one of the vertical crack(s), the horizontal crack(s), and the sliver(s) for which the fragment images are connected by the entire judgment processing.

### Third Embodiment

A third embodiment of the present invention will be explained. When doing so, differences from the first or second embodiment will be mainly explained and an explanation about any content in common with the first or second embodiment will be omitted or simplified.

In any one of the first to third embodiments, the model management unit 250 may judge whether to continue using the deep learning model or not, on the basis of reliability obtained from the deep learning model with respect to the judgment result of each of the plurality of fragment images. For example, the processing explained with reference to FIG. 8 may be performed with respect to each of the models 260A to 260D.

Moreover, in this embodiment, if a volume of teacher data including the relevant fragment image and the type corresponding to that fragment image is less than a certain volume with respect to each fragment image, the teacher data is designed so that, regarding each fragment image for the teacher data, the relevant fragment image is classified as any one of two or more detailed types belonging to the specified defect type or any one of two or more detailed types belonging to the non-defect type; and the model management unit 250 may learn a deep learning model(s) by using the teacher data. This may be performed, for example, for each of the models 260A to 260D.

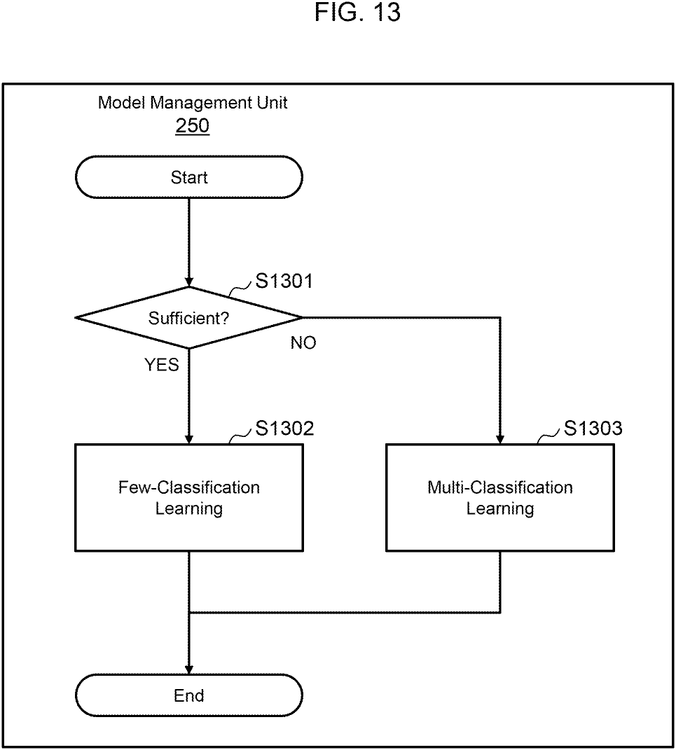

Specifically speaking, for example, processing illustrated in FIG. 13 may be performed with respect to each of the models 260A to 260D. One deep learning model will be taken as an example. The model management unit 250 judges whether a data volume of the teacher data for the deep learning model is sufficient (equal to or larger than a threshold value) or not (S1301).

If the judgment result in S1301 is true (S1301: YES), the model management unit 250 performs few-classification learning (S1302). The “few-classification learning” means that a prepared type(s) in the teacher data to be used for learning with respect to either the specified defect type or the non-defect types (types other than the specified defect type) is/are the specified defect type itself or the non-defect types themselves, or minor types.

On the other hand, if the judgment result in S1301 is false (S1301: NO), the model management unit 250 performs multi-classification learning (S1303). The “multi-classification learning” means that the number of the prepared types in the teacher data to be used for learning with respect to either the specified defect type or the non-defect types (types other than the specified defect type) is larger than the teacher data to be used for the few-classification learning. If the data volume of the teacher data is insufficient, the fragment images regarding both the specified defect type and the non-defect types are classified as more detailed types (in other words, the specified defect type and each rough type of the non-defect types are associated with a plurality of detailed types and the fragment images are classified into the detailed types) and, therefore, the deep learning model can be expected to become a model with high accuracy in spite of the data volume of the teacher data.

Some embodiments have been described above, which have illustrated examples in order to explain the present invention, and there is no intention to limit the scope of the present invention to only these embodiments. The present invention can be also implemented in various other forms.

450: test apparatus

1. A test apparatus comprising:
an individual judgment unit that inputs each of a plurality of fragment images, which are extracted from a test image of a work, into a learning model which receives an image as input and outputs a type, and thereby judges, with respect to each of the plurality of fragment images, the type of the fragment image; and
an entire judgment unit that judges whether or not a defect of a specified defect type is captured in the test image, on the basis of whether the judged type with respect to each of the plurality of fragment images is the specified defect type or not.

2. The test apparatus according to claim 1,
wherein the specified defect type is a crack;
wherein the learning model is a deep learning model for cracks;
wherein the fragment image whose judged type is the crack is a crack fragment image; and
wherein if a crack length identified from one or a plurality of crack fragment images aligned in a one-dimensional direction satisfies a crack length condition which is a condition regarding a length, the entire judgment unit judges that the crack is captured in the test image.

3. The test apparatus according to claim 2,
wherein if the crack length identified from two or more crack fragment images which are consecutive in a one-dimensional direction satisfies the crack length condition, the entire judgment unit judges that the crack is captured in the test image.

4. The test apparatus according to claim 3,
wherein if there is a distance between the crack fragment images and the distance is less than an allowable distance, the entire judgment unit recognizes the distance as part of a crack.

5. The test apparatus according to claim 4,
wherein if the distance between the crack fragment images is less than the allowable distance even when one or more non-crack fragment images exist between the crack fragment images, the entire judgment unit changes the judgment result of the fragment image to the crack with respect to each of the one or more non-crack fragment images.

6. The test apparatus according to claim 1,
wherein the specified defect type is a sliver;
wherein the learning model is a deep learning model for slivers;
wherein the fragment image whose judged type is the sliver is a sliver fragment image; and
wherein if a sliver’s square measure and/or a sliver’s density identified from one or a plurality of sliver fragment images aligned in two-dimensional directions satisfies a square measure / density condition which is a condition regarding a square measure and/or a density, the entire judgment unit judges that the sliver is captured in the test image.

7. The test apparatus according to claim 6,
wherein if the sliver’s square measure and/or the sliver’s density identified from two or more sliver fragment images which are consecutive in two-dimensional directions satisfies the square measure / density condition, the entire judgment unit judges that the sliver is captured in the test image.

8. The test apparatus according to claim 7,
wherein if there is a distance between the sliver fragment images and the distance is less than an allowable distance, the entire judgment unit recognizes the distance as part of a sliver.

9. The test apparatus according to claim 8,
wherein if the distance between the sliver fragment images is less than the allowable distance even when one or more non-sliver fragment images exist between the sliver fragment images, the entire judgment unit changes the judgment result of the fragment image to the sliver with respect to each of the one or more non-sliver fragment images.

10. The test apparatus according to claim 1,
further comprising a display control unit that displays a test result based on test result information including information indicating a result of the judgment by the entire judgment unit,
wherein the test result includes:
a judgment result of whether or not the defect of the specified defect type is captured in the test image; and
a reason which is a reason for the judgment result, that is, a reason including whether or not a condition for judging that the defect of the specified defect type is captured is satisfied.

11. The test apparatus according to claim 1,
wherein a condition for judging that the defect of the specified defect type is captured is a condition defined in work specifications corresponding to a customer of the work among work specifications defined for each customer to whom the work is to be provided.

12. The test apparatus according to claim 1,
further comprising a model management unit,
wherein the learning model is a deep learning model; and
wherein the model management unit judges whether or not to continue using the deep learning model, on the basis of reliability obtained from the deep learning model with respect to the judgment result of each of the plurality of fragment images.

13. The test apparatus according to claim 1,
wherein the work is a work made of ceramics.

14. The test apparatus according to claim 1,
wherein regarding each of a plurality of defect types including the specified defect type, there is a learning model corresponding to the defect type; and
wherein regarding each of the plurality of defect types,
the individual judgment unit inputs each of a plurality of fragment images, which are extracted from the test image, into the learning model corresponding to the defect type and thereby judges a type of the fragment image with respect to each of the plurality of fragment images; and
the entire judgment unit judges whether a defect corresponding to the defect type is captured in the test image or not, on the basis of whether the type which is judged regarding each of the plurality of fragment images corresponds to the defect type or not.

15. The test apparatus according to claim 1,
further comprising a model management unit,
wherein the learning model is a deep learning model; and
wherein regarding each fragment image, if a volume of teacher data including the fragment image and a type corresponding to the fragment image is less than a certain volume,
the teacher data is designed so that, regarding each fragment image for the teacher data, the fragment image is classified as any one of two or more detailed types belonging to the specified defect type or any one of two or more detailed types belonging to the non-defect types; and
the model management unit learns the deep learning model by using the teacher data.

16. A test method comprising:
inputting, by a computer, each of a plurality of fragment images, which are extracted from a test image of a work, into a learning model which receives an image as input and outputs a type, and thereby judging the type with respect to each of the plurality of fragment images; and
judging, by the computer, whether or not a defect of a specified defect type is captured in the test image, on the basis of whether or not the judged type with respect to each of the plurality of fragment images is the specified defect type.

17. A non-transitory computer-readable storage medium storing a computer program to cause a computer to:
input each of a plurality of fragment images, which are extracted from a test image of a work, into a learning model which receives an image as input and outputs a type, and thereby judge the type with respect to each of the plurality of fragment images; and
judge whether or not a defect of a specified defect type is captured in the test image, on the basis of whether or not the judged type with respect to each of the plurality of fragment images is the specified defect type.
